(19) United States
(12) Patent Application Publication
(10) Pub. No.: US 2023/0288924 A1
(43) Pub. Date: Sep. 14, 2023

(54) PORTABLE DEVICE, SETTING INFORMATION TRANSMISSION METHOD, AND NON-TRANSITORY RECORDING MEDIUM

(71) Applicant: TOYOTA JIDOSHA KABUSHIKI KAISHA, Toyota-shi (JP)

(72) Inventor: Jun IKEDA, Nagoya-shi (JP)

(73) Assignee: TOYOTA JIDOSHA KABUSHIKI KAISHA, Toyota-shi (JP)

(21) Appl. No.: 18/157,890

(22) Filed: Jan. 23, 2023

(30) Foreign Application Priority Data
Mar. 9, 2022 (JP) 2022-036178

(51) Int. Cl. G05D 1/00; B60R 25/01

(52) U.S. Cl. CPC G05D 1/0016; G05D 1/0022; G05D 1/0027; B60R 25/01

(57) ABSTRACT

A portable device including a processor, wherein the processor is configured to: acquire setting information relating to user settings of an onboard device of a first vehicle; and in a case in which a distance between the portable device and a second vehicle, which is different from the first vehicle and includes another onboard device, is a predetermined distance or less, cause transmission of the setting information to the second vehicle.

### CROSS-REFERENCE TO RELATED APPLICATION

This application is based on and claims priority under 35 USC 119 from Japanese Patent Application No. 2022-036178 filed on Mar. 9, 2022, the disclosure of which is incorporated by reference herein.

### BACKGROUND

### Technical Field

The present disclosure relates to a portable device, a setting information transmission method, and a non-transitory recording medium.

### Related Art

Japanese Patent Application Laid-Open (JP-A) No. 2019-034684 discloses an invention in which a second vehicle, which is different from a first vehicle, receives setting information for the first vehicle by wireless communication from an external server, and performs predetermined setting based on the setting information. The first vehicle is a particular vehicle and is recorded in the external server.

In a case in which a failure has occurred in wireless communication between the second vehicle and the external server, the second vehicle cannot perform setting based on the setting information.

In consideration of the above circumstances, an object of the present disclosure is to provide a portable device, a setting information transmission method, and a non-transitory recording medium that enable a vehicle to receive setting information even in a case in which a failure has occurred in wireless communication between a device holding setting information and the vehicle.

### SUMMARY

A portable device according to a first aspect of the present disclosure includes a processor configured to: acquire setting information relating to user settings of an onboard device of a first vehicle; and in a case in which a distance between the portable device and a second vehicle, which is different from the first vehicle and includes another onboard device, is a predetermined distance or less, cause transmission of the setting information to the second vehicle.

The processor of the portable device according to the first aspect acquires setting information relating to user settings of the onboard device of the first vehicle. The processor of the portable device causes transmission of the setting information to the second vehicle in a case in which the distance between the portable device and the second vehicle, which is different from the first vehicle and includes another onboard device, is a predetermined distance or less. This enables the second vehicle to receive the setting information even in a case in which a failure has occurred in wireless communication between a device holding the setting information and the second vehicle.

The setting information transmitted to the second vehicle includes setting information processed so as to enable the setting information of the first vehicle to be used by the second vehicle.

A setting information transmission method according to a thirteenth aspect of the present disclosure is a method of transmitting, from a portable device to a vehicle, setting information relating to user settings of an onboard device, the method including, by a processor: acquiring the setting information of the onboard device, wherein the onboard device is in a first vehicle; and in a case in which a distance between the portable device and a second vehicle, which is different from the first vehicle, is a predetermined distance or less, causing transmission of the setting information to the second vehicle which includes another onboard device.

A non-transitory recording medium according to a fourteenth aspect of the present disclosure is a non-transitory recording medium storing a program executable by a computer to perform processing, the processing including: acquiring setting information relating to user settings of an onboard device of a first vehicle; and in a case in which a distance to a second vehicle, which is different from the first vehicle and includes another onboard device, is a predetermined distance or less, causing transmission of the setting information to the second vehicle.

A portable device, a setting information transmission method, and a non-transitory recording medium according to the present disclosure are capable of enabling a vehicle to receive setting information even in a case in which a failure has occurred in wireless communication between a device holding the setting information and the vehicle.

### BRIEF DESCRIPTION OF THE DRAWINGS

Exemplary embodiments of the present disclosure will be described in detail based on the following figures, wherein:

FIG. 1 is an overall diagram of a car sharing system including a portable device according to the present exemplary embodiment.

FIG. 2 is a control block diagram of a management server and the portable device illustrated in FIG. 1.

FIG. 3 is a functional block diagram of the management server.

FIG. 4 is a schematic cross-sectional plan view of a first vehicle and a second vehicle.

FIG. 5 is a side view of a driver's seat and an interior light of the first vehicle and the second vehicle.

FIG. 6 is a block diagram of an ECU of the first vehicle and the second vehicle.

FIG. 7 is a functional block diagram of the ECU of the first vehicle.

FIG. 8 is a diagram illustrating a setting information list.

FIG. 9 is a functional block diagram of the ECU of the second vehicle.

FIG. 10 is a functional block diagram of the portable device.

FIG. 11 is a sequence diagram illustrating a flow of control of an entirety of the car sharing system.

FIG. 12 is a flowchart illustrating processing executed by a CPU of the management server.

FIG. 13 is a flowchart illustrating processing executed by a CPU of the second vehicle.

FIG. 14 is a flowchart illustrating processing executed by the CPU of the second vehicle.

FIG. 15 is a flowchart illustrating processing executed by a CPU of the portable device.

FIG. 16 is a flowchart illustrating processing executed by the CPU of the portable device.

### DETAILED DESCRIPTION

Explanation follows regarding a portable device, a setting information transmission method, and a non-transitory recording medium according to an exemplary embodiment of the present disclosure.

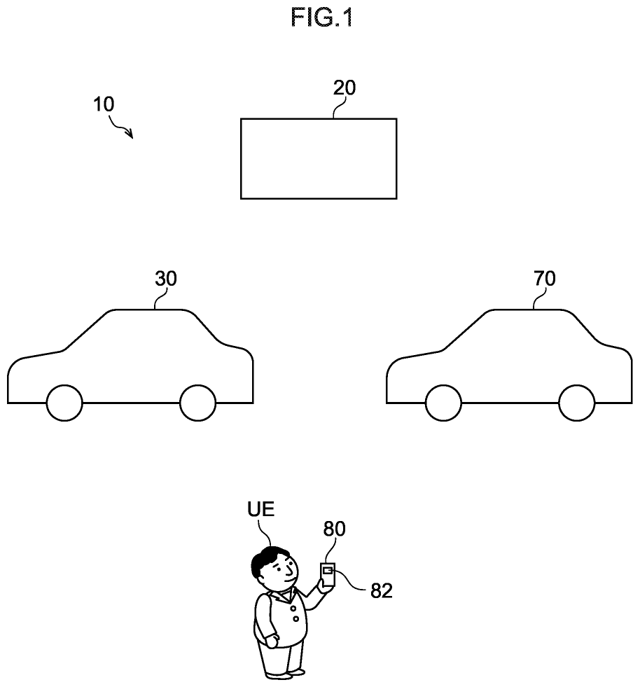

As illustrated in FIG. 1, a car sharing system 10 (hereinafter referred to as the system 10) of the present exemplary embodiment includes a management server (an external device) 20, a first vehicle 30, a second vehicle 70, and a portable device 80.

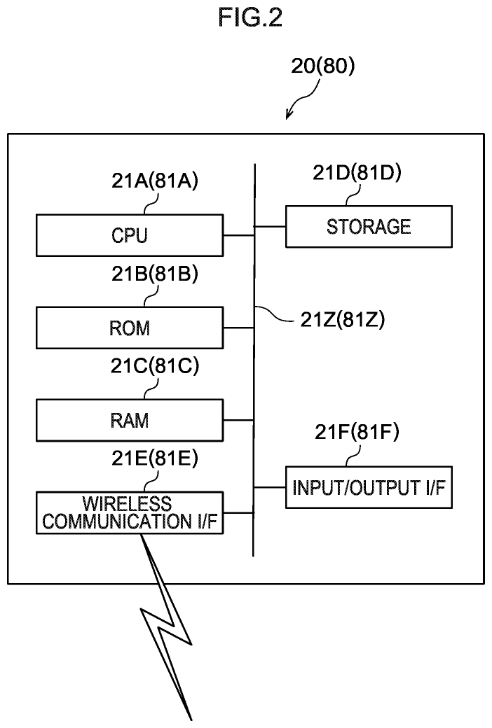

The management server 20 is installed inside a building (not illustrated) owned by an administrator of the system 10. As illustrated in FIG. 2, the management server 20 includes, as a hardware configuration, a central processing unit (CPU) (processor) 21A, read only memory (ROM) 21B, random access memory (RAM) 21C, storage 21D, a wireless communication interface (I/F) 21E, and an input/output I/F 21F. The CPU 21A, the ROM 21B, the RAM 21C, the storage 21D, the wireless communication I/F 21E, and the input/output I/F 21F are connected together via an internal bus 21Z so as to be capable of communicating with each other. The CPU 21A and the respective CPUs, which are described below, are capable of acquiring information relating to time from a timer.

The CPU 21A is a central processing unit that executes various programs and controls various sections. The CPU 21A reads a program from the ROM 21B or the storage 21D, and executes the program using the RAM 21C as a workspace. The CPU 21A controls the respective configurations and performs various computation processing in accordance with a program recorded in the ROM 21B or the storage 21D.

The ROM 21B stores various programs and various data. For example, plural programs are installed in the ROM 21B. For example, a member list (not illustrated) including personal information for users who are members of the system 10 is recorded in the ROM 21B. The RAM 21C serves as a workspace to temporarily store programs and data. The storage 21D is configured by a storage device such as a hard disk drive (HDD) or a solid state drive (SSD), and stores various programs and various data. For example, a setting information list 25, which is described below, is recorded in the storage 21D.

The wireless communication I/F 21E is an interface for wirelessly communicating with various devices. For example, the wireless communication I/F 21E is capable of communicating wirelessly with the first vehicle 30, the second vehicle 70, and the portable device 80 via a network (for example, the Internet).

The input/output I/F 21F is an interface for communicating with various devices.

Note that the CPUs (computers), ROMs (non-transitory storage media), RAMs, storage (non-transitory storage media), wireless communication I/Fs, input/output I/Fs, and internal buses of the first vehicle 30, the second vehicle 70, and the portable device 80, which are described below, have similar functionality to the CPU 21A, the ROM 21B, the RAM 21C, the storage 21D, the wireless communication I/F 21E, the input/output I/F 21F, and the internal bus 21Z, respectively.

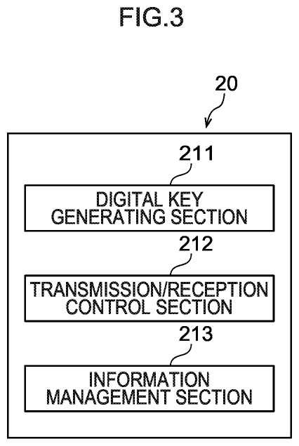

FIG. 3 is a block diagram illustrating an example of a functional configuration of the management server 20. The management server 20 includes, as a functional configuration, a digital key generating section 211, a transmission/reception control section 212, and an information management section 213. These are implemented by the CPU 21A reading and executing a program stored in the ROM 21B.

The digital key generating section 211 generates a digital key used by a user when using a vehicle of the system 10. The digital key generating section 211 is capable of setting an expiration date for the generated digital key.

The transmission/reception control section 212 controls the wireless communication I/F 21E. The wireless communication I/F 21E, which is controlled by the transmission/reception control section 212, is capable of recording data, received from an outside, in the ROM 21B and the storage 21D. Moreover, the wireless communication I/F 21E, which is controlled by the transmission/reception control section 212, is capable of wirelessly transmitting a digital key generated by the digital key generating section 211 to a vehicle of the system 10 and a portable device of a user, and of wirelessly transmitting data recorded in the ROM 21B and the storage 21D to an outside.

The information management section 213 records the received setting information in the storage 21D when the wireless communication I/F 21E receives the setting information from the first vehicle 30. Namely, the information management section 213 generates the setting information list 25, which is described below.

The first vehicle 30 illustrated in FIG. 1 is owned by a user UE that is a member of the system 10.

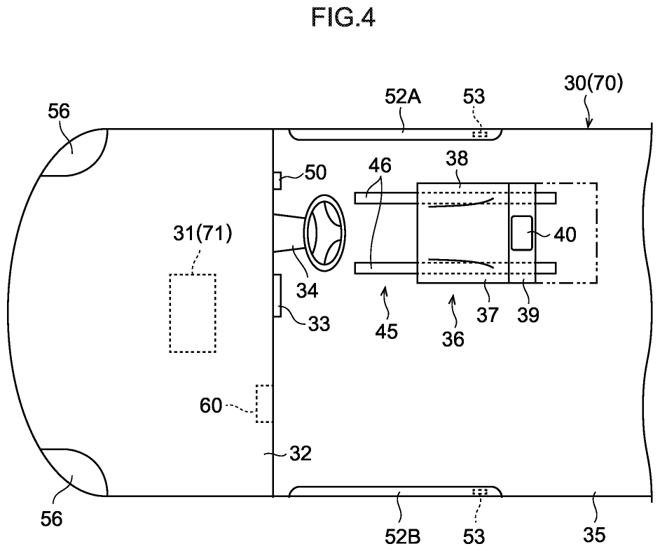

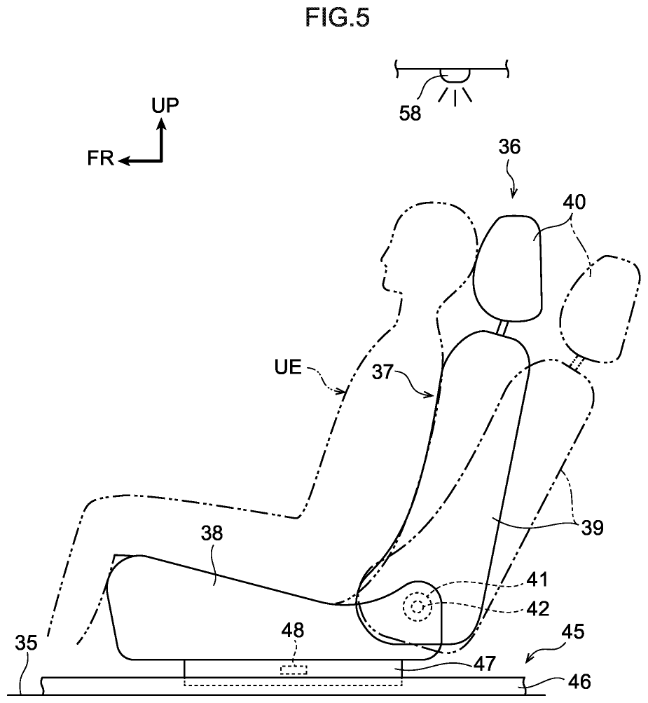

As illustrated in FIG. 4, an instrument panel 32 of the first vehicle 30 is provided with a touch panel type display 33 and a steering wheel 34. Moreover, as illustrated in FIG. 4 and FIG. 5, a driver's seat (a movable member) (an onboard device) 36, which is a movable seat, is provided at a floor 35, which is a bottom surface of a vehicle cabin. The driver's seat 36 includes a seat main body 37 and a slide rail device 45.

As illustrated in FIG. 5, the slide rail device 45, which supports the seat main body 37 of the driver's seat 36 so as to be slidable in a front-rear direction, is provided at the floor 35. The slide rail device 45 includes a left and right pair of lower rails 46 fixed to the floor 35 and extending in the front-rear direction, and a left and right of upper rails 47 supported by the respective lower rails 46 so as to be slidable in the front-rear direction. The slide rail device 45 further includes an actuator 48 configured by an electric pulse motor, and a power transmission mechanism (not illustrated).

The seat main body 37 includes a seat cushion 38, a seat back 39, and a headrest 40. The seat cushion 38 is fixed to the left and right upper rails 47.

As illustrated in FIG. 5, the rear end portion of the seat cushion 38 and the lower end portion of the seat back 39 are rotatably connected via a reclining mechanism 41. An actuator 42 configured by an electric pulse motor is provided at the reclining mechanism 41.

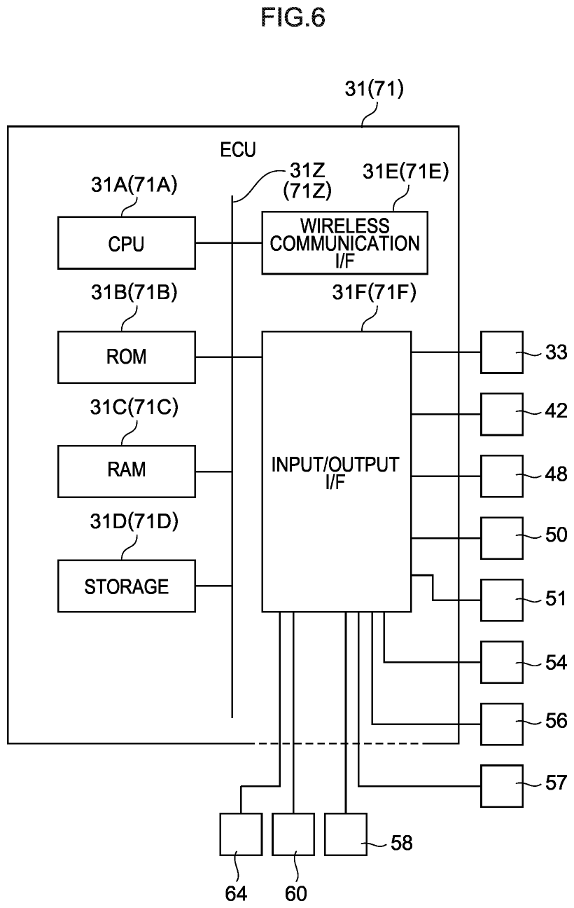

As illustrated in FIG. 4, a driving assistance switch 50 is provided at the instrument panel 32. Moreover, a vehicle speed sensor 51 (see FIG. 6) is provided at the first vehicle 30.

As illustrated in FIG. 4, the first vehicle 30 is provided with doors 52A and 52B that open and close openings formed at the sides of the vehicle body. The respective doors 52A and 52B are movable relative to the vehicle body between a closed position (the position in FIG. 4) in which the corresponding opening is closed, and an open position (not illustrated) in which the opening is open. Moreover, a door lock device 53 including an actuator 54 (see FIG. 6) configured by an electric motor is provided at each of the doors 52A and 52B. The respective door lock devices 53 are switchable between a locked state (latched state) in which the doors 52A and 52B situated at the closed position are held at the closed position, and an unlocked state (unlatched state) in which the doors 52A and 52B are allowed to move between the closed position and the open position using a driving force of the actuator 54.

As illustrated in FIG. 4, a left and right pair of headlights 56 are provided at a front portion of the first vehicle 30. Moreover, as illustrated in FIG. 6, the first vehicle 30 is provided with a light sensor 57 that detects the brightness outside the first vehicle 30. Further, as illustrated in FIG. 5 and FIG. 6, an interior light 58 is provided at a ceiling section inside the first vehicle 30. Furthermore, as illustrated in FIG. 4, the first vehicle 30 is provided with an audio device 60. The audio device 60 includes a speaker (not illustrated). As further illustrated in FIG. 6, the first vehicle 30 includes a push-type start button 64.

As illustrated in FIG. 4 and FIG. 6, the first vehicle 30 is provided with an ECU 31. The ECU 31 includes a CPU 31A (processor), ROM 31B, RAM 31C, storage 31D, a wireless communication I/F 31E, an input/output I/F 31F, and an internal bus 31Z.

For example, a navigation application is installed in the ROM 31B. Namely, a navigation system is installed at the first vehicle 30.

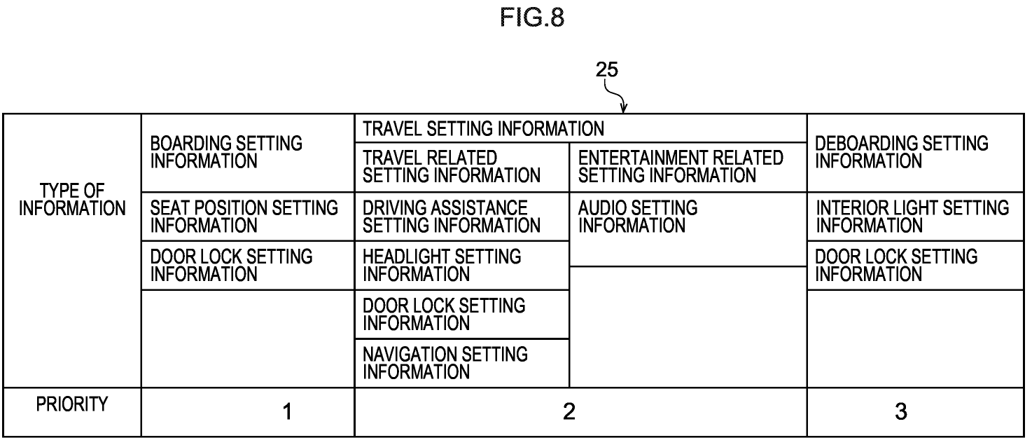

For example, setting information, which is information relating to user settings of onboard devices that are devices provided at the first vehicle 30, is recorded in the storage 31D. For example, the setting information for the first vehicle 30 can be input using the display 33 (touch panel). The first vehicle 30 and the onboard devices of the vehicle group of the system 10 described below include various devices. For example, onboard devices include the display 33, the steering wheel 34, the driver's seat 36, the door lock devices 53, the headlights 56, the light sensor 57, the interior light 58, the audio device 60, the car navigation system, and an execution system of driving assistance control. As illustrated in FIG. 8, the setting information for the first vehicle 30 includes boarding setting information, travel setting information, and deboarding setting information.

The boarding setting information is setting information relating to onboard devices that may be controlled, based on user settings, before the vehicle begins travel. In the present exemplary embodiment, the boarding setting information includes seat position setting information and door lock setting information. The seat position setting information includes information relating to a sliding position, which is a position in a front-rear direction of the upper rails 47 (the seat main body 37) with respect to the lower rails 46, and a reclining position, which is a position in a rotational direction of the seat back 39 with respect to the seat cushion 38. The door lock setting information is information relating to the volume of sound generated by the speaker when the door lock devices 53 in the locked state are switched to the unlocked state using the portable device situated outside the first vehicle 30.

The travel setting information is setting information relating to onboard devices that may be controlled, based on user settings, when the vehicle is traveling. The travel setting information includes travel-related setting information and entertainment related setting information.

The travel-related setting information is setting information relating to onboard devices that may be controlled, based on user settings, when the vehicle is traveling, and is also setting information relating to safe travel of the vehicle. In the present exemplary embodiment, the travel-related setting information includes driving assistance setting information, headlight setting information, door lock setting information, and navigation setting information. The driving assistance setting information includes information relating to the content of driving assistance control executed during travel of the first vehicle 30. The driving assistance control of the present exemplary embodiment includes various driving assistance control of Levels 1 to 5 determined by the Society of Automotive Engineers (SAE) (American Society of Automotive Engineers). The headlight setting information includes information relating to a magnitude of a detection value (a first threshold value) of the light sensor 57 when autonomous lighting control, which is described below, is executed. The door lock setting information includes information relating to automatic door lock control and automatic door unlock control. Note that automatic door lock control is control to switch the door lock devices 53 that were in an unlocked state to a locked state when the vehicle speed detected by the vehicle speed sensor 51 reaches a predetermined value. The automatic door unlock control is control to switch the door lock devices 53 that were in a locked state to an unlocked state when it is determined that the first vehicle 30 has stopped. The navigation setting information includes information relating to a scale of a map displayed at the display 33, a display direction of the map, and a language and a unit representing length (distance) of the map.

The entertainment related setting information is setting information relating to onboard devices that may be controlled, based on user settings, when the vehicle is traveling, and is not related to safe travel of the vehicle. In the present exemplary embodiment, the entertainment related setting information includes audio setting information. The audio setting information includes volume setting information for the above-described speaker, and setting information relating to Bluetooth Low Energy (BLE) (registered trademark) communication, which is communication conforming to a Bluetooth (registered trademark) standard between a wireless earphone (not illustrated) worn by the user UE and the wireless communication I/F 31E.

The deboarding setting information is setting information relating to onboard devices that may be controlled, based on user settings, after the user deboards the vehicle. In the present exemplary embodiment, the deboarding setting information includes interior light setting information and door lock setting information. The interior light setting information includes information relating to a time (a second threshold value) during which the lighting state of the interior light 58 is maintained in a case in which the doors 52A and 52B are switched from the open state to the closed state under the condition in which the start button 64 is off. The door lock setting information is information relating to the volume of sound generated by the above-described speaker when the door lock devices 53 in the unlocked state are switched to the locked state using the portable device 80 situated outside the first vehicle 30.

As illustrated in FIG. 6, the display 33, the actuator 42, the actuator 48, the driving assistance switch 50, the vehicle speed sensor 51, the actuator 54, the headlights 56, the light sensor 57, the interior light 58, the audio device 60, and the start button 64 are connected to the input/output I/F 31F.

The wireless communication I/F 31E is capable of executing wireless communication with an external communication device via a network (for example, the Internet). The wireless communication I/F 31E is capable of performing Bluetooth Low Energy (BLE) (registered trademark) communication with the portable device 80, which is described below.

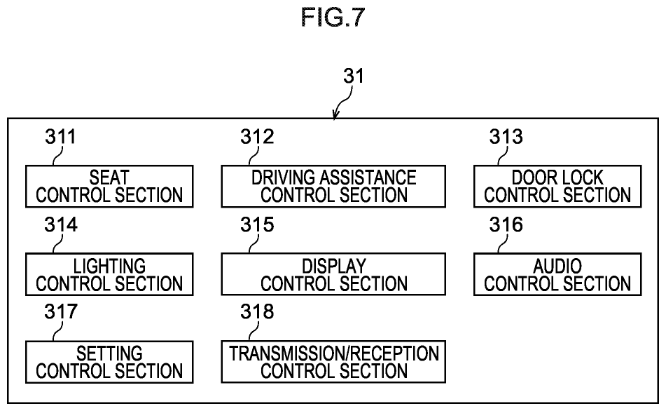

FIG. 7 is a block diagram illustrating an example of a functional configuration of the ECU 31. The ECU 31 includes, as a functional configuration, a seat control section 311, a driving assistance control section 312, a door lock control section 313, a lighting control section 314, a display control section 315, an audio control section 316, a setting control section 317, and a transmission/reception control section 318. These are implemented by the CPU 31A reading and executing a program stored in the ROM 31B.

The seat control section 311 controls at least one of the actuator 42 or the actuator 48 to change at least one of a sliding position or a reclining position of the driver's seat 36. For example, when a position control switch (not illustrated) provided at the driver's seat 36 is operated, the seat control section 311 controls the actuator 42 to change the reclining position of the driver's seat 36. Moreover, when the position control switch is operated, the seat control section 311 controls the actuator 48 to change the sliding position of the driver's seat 36.

The driving assistance control section 312 executes driving assistance control selected by the driving assistance switch 50 when the driving assistance switch 50 is operated. For example, when adaptive cruise control (ACC) is selected by the driving assistance switch 50, the driving assistance control section 312 controls the drive source and the brake device (neither of which are illustrated) of the first vehicle 30. This causes the first vehicle 30 to travel so as to maintain a following distance between the first vehicle 30 and a preceding vehicle (not illustrated) located ahead of the first vehicle 30 at a set distance.

For example, when the wireless communication I/F 31E receives a lock control signal from the portable device 80, the door lock control section 313 controls the actuators 54 to switch the door lock devices 53 from the unlocked state to the locked state. Moreover, when the wireless communication I/F 31E receives an unlock control signal from the portable device 80, the door lock control section 313 controls the actuators 54 to switch the door lock devices 53 from the locked state to the unlocked state.

The lighting control section 314 performs autonomous lighting control when the detection value of the light sensor 57 has reached or exceeded the predetermined first threshold value. Namely, the lighting control section 314 automatically turns on the headlights 56. Moreover, under the condition in which the start button 64 is off, when a time corresponding to the second threshold value has elapsed since the doors 52A and 52B were switched from the open state to the closed state, the lighting control section 314 turns off the interior light 58 that was in a lit state.

The display control section 315 controls the display 33. For example, when the navigation application is running, based on the navigation setting information, the display control section 315 changes the scale of the map displayed at the display 33, the display direction of the map, and the language and the unit representing the length (distance) of the map.

The audio control section 316 controls the audio device 60. For example, based on the audio setting information, the audio control section 316 changes the volume of the above-described speaker and conditions relating to BLE communication between the wireless earphone worn by the user UE and the wireless communication I/F 31E.

The setting control section 317 records the setting information for the first vehicle 30 in the storage 31D. For example, assume a case in which the sliding position and the reclining position of the driver's seat 36 are respectively at predetermined positions. In this state, when the user UE inputs a seat position determination instruction into the display 33 (touch panel), the setting control section 317 records the seat position setting information relating to the sliding position and the reclining position at this time in the storage 31D as setting information. Moreover, using the display 33 (touch panel), when the driving assistance setting information, the headlight setting information (the first threshold value), the navigation setting information, the audio setting information, the interior light setting information (the second threshold), and the door lock setting information of the boarding setting information, the travel setting information, and the deboarding setting information are input, the setting control section 317 records these pieces of information in the storage 31D.

When the setting information is recorded in the storage 31D, the seat control section 311, the driving assistance control section 312, the door lock control section 313, the lighting control section 314, the display control section 315, and the audio control section 316 perform control based on the setting information recorded in the storage 31D. For example, in a case in which the sliding position and the reclining position of the driver's seat 36 are recorded in the storage 31D as setting information, the seat control section 311 sets the sliding position and the reclining position of the driver's seat 36 to a position represented by the setting information. Moreover, in a case in which driving assistance setting information is recorded in the storage 31D, the driving assistance control section 312 executes driving assistance control based on this driving assistance setting information. Further, in a case in which information to execute automatic door lock control and automatic door unlock control is recorded in the storage 31D as door lock setting information, the door lock control section 313 executes automatic door lock control and automatic door unlock control.

Moreover, each time the setting information is updated, the setting control section 317 controls the wireless communication I/F 31E so as to wirelessly transmit, to the management server 20, the setting information recorded in the storage 31D. In a case in which the wireless communication I/F 21E receives the latest setting information from the first vehicle 30, the information management section 213 of the management server 20 creates (updates) the setting information list 25 illustrated in FIG. 8, and records this in the storage 21D. The setting information list 25 includes all of the setting information relating to the first vehicle 30. The setting information list 25 further includes vehicle ID information, which is ID information for the vehicle corresponding to the setting information, and member ID information, which is ID information for the member. The setting information list 25 includes information relating to priority. The setting information list 25 of the present exemplary embodiment indicates that the priority of the boarding setting information is “1”, the priority of the travel setting information is “2”, and the priority of the deboarding setting information is “3”. The smaller the number representing the priority, the higher the priority.

The transmission/reception control section 318 controls the wireless communication I/F 31E. The wireless communication I/F 31E, which is controlled by the transmission/reception control section 318, is capable of recording data received from an outside in the ROM 31B and the storage 31D, and of wirelessly transmitting the data recorded in the ROM 31B and the storage 31D to an outside.

The second vehicle 70 illustrated in FIG. 1 is one of many vehicles managed by the above-described administrator. The second vehicle 70 is a selected vehicle that is selected by the user UE from this vehicle group. The vehicle type of the second vehicle 70 is the same as the vehicle type of the first vehicle 30. In other words, the vehicle type code of the second vehicle 70 is the same as the vehicle type code of the first vehicle 30. Namely, the hardware configuration of the second vehicle 70 is the same as the hardware configuration of the first vehicle 30, and the same program (application) as that installed in the ECU 31 of the first vehicle 30 is installed in the ECU 71 of the second vehicle 70.

As illustrated in FIG. 6, the ECU 71 of the second vehicle 70 includes a CPU 71A, ROM 71B, RAM 71C, storage 71D, a wireless communication I/F 71E, an input/output I/F 71F, and an internal bus 71Z.

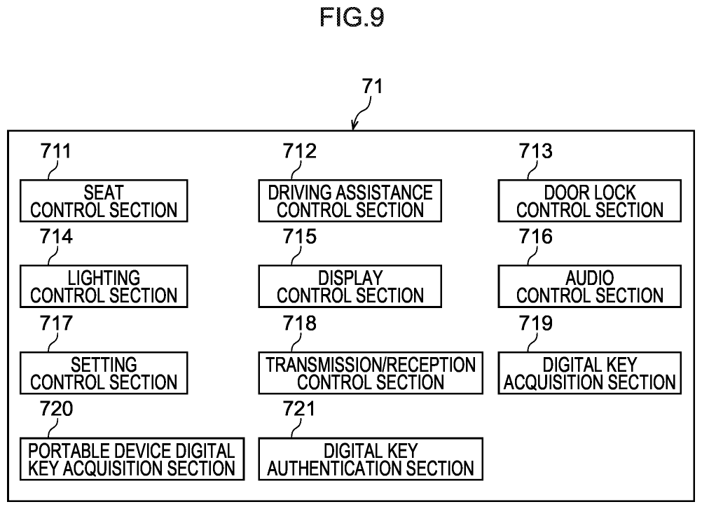

As illustrated in FIG. 4 to FIG. 6, the second vehicle 70, which is of the same vehicle type as the first vehicle 30, has the same configuration as the first vehicle 30. As illustrated in FIG. 9, the ECU 71 of the second vehicle 70 further includes, as a functional configuration, a seat control section 711, a driving assistance control section 712, a door lock control section 713, a lighting control section 714, a display control section 715, an audio control section 716, a setting control section 717, and a transmission/reception control section 718, which respectively correspond to the seat control section 311, the driving assistance control section 312, the door lock control section 313, the lighting control section 314, the display control section 315, the audio control section 316, the setting control section 317, and the transmission/reception control section 318. The ECU 71 further includes, as a functional configuration, a digital key acquisition section 719, a portable device digital key acquisition section 720, and a digital key authentication section 721.

The digital key acquisition section 719 acquires a digital key wirelessly transmitted by the management server 20 when the wireless communication I/F 71E receives this digital key.

The portable device digital key acquisition section 720 acquires a digital key (authentication data) from a portable device (for example, the portable device 80) via a Bluetooth Low Energy (BLE) (registered trademark) link established with the portable device.

The digital key authentication section 721 performs digital key authentication using the digital key acquired by the digital key acquisition section 719 and the digital key acquired by the portable device digital key acquisition section 720.

The user UE may inform the administrator in the above-described building of which vehicle is the selected vehicle. In this case, the administrator inputs information relating to the selected vehicle of the user UE into an operation terminal (not illustrated) connected to the management server 20. The information relating to the selected vehicle input into the operation terminal is transmitted from the operation terminal to the management server 20, and is recorded in the storage 21D. Alternatively, the user UE may input the information relating to the selected vehicle into the portable device 80 via the display (input section) 82. In this case, the portable device 80 wirelessly transmits the information relating to the selected vehicle input into the portable device 80 to the management server 20, and the management server 20 records the received information relating to the selected vehicle in the storage 21D. Moreover, the transmission/reception control section 212 of the management server 20 transmits the digital key to the portable device 80 and the second vehicle 70 which is the selected vehicle.

The portable device 80 illustrated in FIG. 1 is owned by the user UE. The portable device 80 includes a touch panel type display 82. The portable device 80 is, for example, a smart key or a smart phone.

As illustrated in FIG. 2, the portable device 80 includes, as a hardware configuration, a CPU (processor) 81A, ROM 81B, RAM 81C, storage 81D, a wireless communication I/F 81E, an input/output I/F 81F, and an internal bus 81Z.

For example, a car sharing application is installed in the ROM 81B. Moreover, member ID information for the user UE is recorded in the ROM 81B.

The wireless communication I/F 81E is capable of communicating wirelessly with the management server 20, the first vehicle 30, and the second vehicle 70 via a network (for example, the Internet). Moreover, the wireless communication I/F 81E is capable of executing BLE communication with a vehicle group of the system 10.

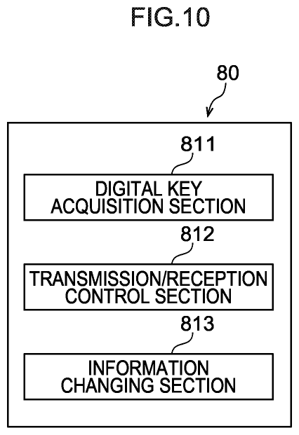

FIG. 10 is a block diagram illustrating an example of a functional configuration of the portable device 80. The portable device 80 includes, as a functional configuration, a digital key acquisition section 811 and transmission/reception control sections (acquisition sections) (processors) 812 and an information changing section 813. These are implemented by the CPU 81A reading and executing a program stored in the ROM 81B.

The digital key acquisition section 811 acquires the digital key wirelessly transmitted by the management server 20 when the wireless communication I/F 81E receives this digital key.

The transmission/reception control section 812 controls the wireless communication I/F 81E. The wireless communication I/F 81E, which is controlled by the transmission/reception control section 812, is capable of recording data, received from an outside, in the ROM 81B and the storage 81D. Moreover, the wireless communication I/F 81E, which is controlled by the transmission/reception control section 812, is capable of wirelessly transmitting the digital key acquired by the digital key acquisition section 811, as well as the data recorded in the ROM 81B and the storage 81D, to an outside.

The information changing section 813 changes the content of the setting information recorded in the storage 81D when an instruction to change the content of the setting information recorded in the storage 81D is input into the portable device 80 via the display 82.

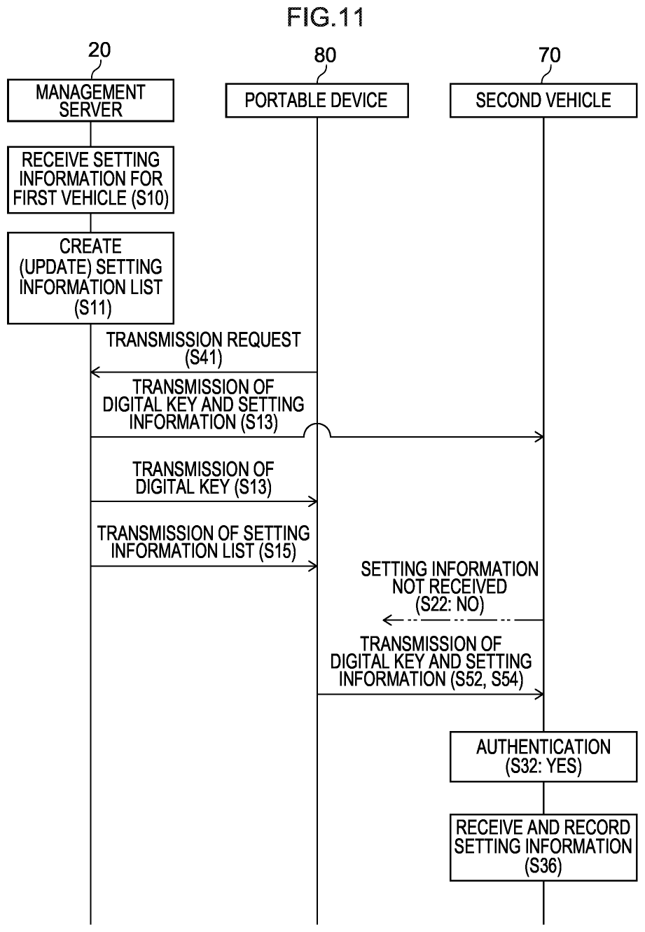

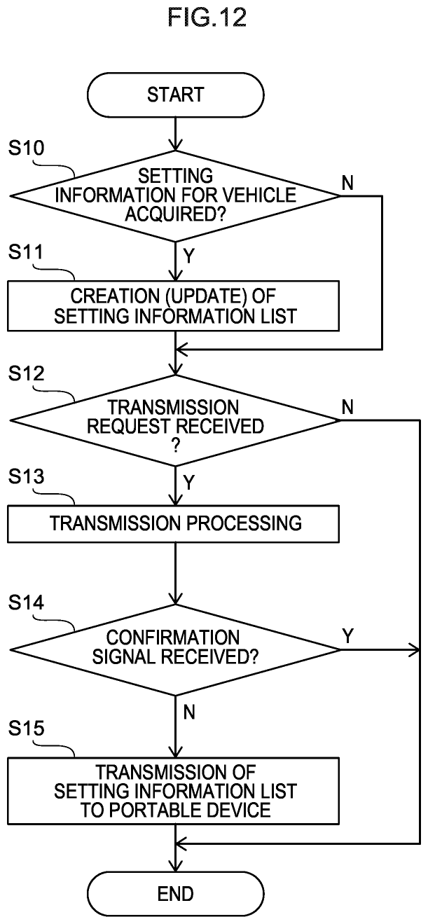

Next, explanation follows regarding a setting information transmission method according to the present exemplary embodiment, with reference to the sequence diagram of FIG. 11 and the flowcharts of FIG. 12 to FIG. 16. Note that in the following explanation, it is assumed that the second vehicle 70 is selected by the user UE as the selected vehicle. Further, although in the following explanation, the processing illustrated in the respective flowcharts of FIG. 12 to FIG. 16 is executed by a single processor (CPU), plural processors (CPUs) may execute the processing illustrated in the respective flowcharts of FIG. 12 to FIG. 16.

The CPU 21A of the management server 20 repeatedly executes the processing of the flowchart of FIG. 12 every time a predetermined period of time elapses.

At step S10, the CPU 21A determines whether or not setting information for the vehicle has been acquired. For example, in a case in which the first vehicle 30 wirelessly transmits the setting information recorded in the storage 31D to the management server 20, the CPU 21A determines YES at step S10, and proceeds to step S11.

At step S11, the CPU 21A creates (updates) the setting information list 25.

Next, at step S12, the CPU 21A determines whether or not the wireless communication I/F 21E has received a transmission request for the setting information list 25. The transmission request can be transmitted by the portable device 80. Note that a transmission request input into the above-described operation terminal may be transmitted from the operation terminal to the management server 20. The transmission request includes vehicle ID information and member ID information, which correspond to the setting information list 25 that is the transmission object, as well as information relating to the vehicle ID of the selected vehicle.

In a case in which the determination at step S12 is YES, the CPU 21A proceeds to step S13, and controls the wireless communication I/F 21E so as to transmit all of the setting information listed in the setting information list 25 to the second vehicle 70. At this time, the management server 20 transmits the respective setting information in an order based on the priority described above. Note that at this time, the management server 20 may transmit the respective setting information in an arbitrary order. Moreover, at step S13, the CPU 21A controls the wireless communication I/F 21E so as to wirelessly transmit the digital key to the second vehicle 70 and the portable device 80.

Next, at step S14, the CPU 21A determines whether or not the wireless communication I/F 21E has received a confirmation signal from the second vehicle 70. As described below, when receiving the setting information included in the setting information list 25, the second vehicle 70 wirelessly transmits a confirmation signal to the management server 20. On the other hand, in a case in which a failure has occurred in wireless communication between the management server 20 and the second vehicle 70, the CPU 21A determines NO at step S14.

In a case in which the determination at step S14 is NO, the CPU 21A proceeds to step S15 to wirelessly transmit the setting information list 25 to the portable device 80. At this time, the management server 20 transmits the respective setting information in an order based on the priority described above. Note that at this time, the management server 20 may transmit the respective setting information in an arbitrary order.

In a case in which the determination at step S12 is NO, in a case in which the determination at step S14 is YES or in a case in which the processing at step S15 has ended, the CPU 21A temporarily ends the processing of the flowchart of FIG. 12.

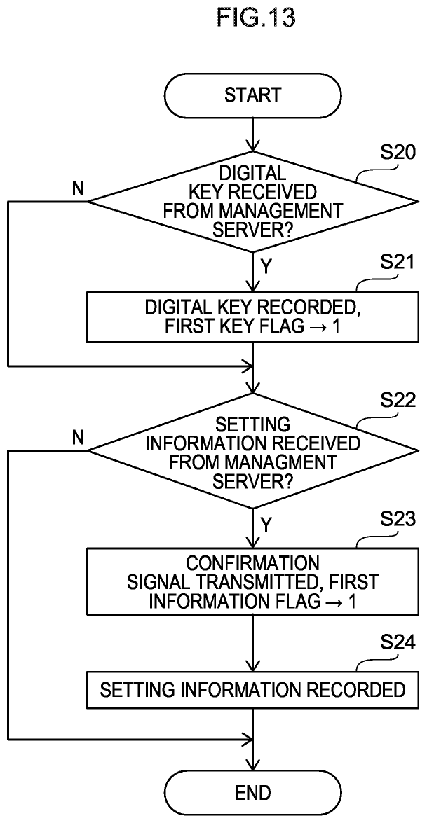

Next, explanation follows regarding processing performed by the CPU 71A of the ECU 71 of the second vehicle 70. The CPU 71A repeatedly executes the processing of the flowchart of FIG. 13 every time a predetermined period of time elapses.

At step S20, the CPU 71A determines whether or not the digital key has been received from the management server 20.

In a case in which the determination at step S20 is YES, the CPU 71A proceeds to step S21, records the acquired digital key in the storage 71D, and sets the value of a first key flag to “1”. Note that the initial value of the first key flag is “0”.

In a case in which the determination at step S20 is NO, or in a case in which the processing at step S21 has ended, the CPU 71A proceeds to step S22 to determine whether or not the respective setting information specified in the setting information list 25 has been received from the management server 20. In a case in which a failure has occurred in wireless communication between the management server 20 and the second vehicle 70, the CPU 71A makes a NO determination at step S22.

In a case in which the determination at step S22 is YES, the CPU 71A proceeds to step S23, and controls the wireless communication I/F 71E so as to transmit the confirmation signal to the management server 20. Moreover, the CPU 71A sets the value of a first information flag to “1”. Note that the initial value of the first information flag is “0”.

Next, the CPU 71A proceeds to step S24, and records the acquired setting information in the storage 71D. This enables the seat control section 711, the driving assistance control section 712, the door lock control section 713, the lighting control section 714, the display control section 715, and the audio control section 716 to perform control based on the setting information recorded in the storage 71D.

In a case in which the determination at step S22 is NO, or in a case in which the processing at step S24 has ended, the CPU 71A temporarily ends the processing of the flowchart of FIG. 13.

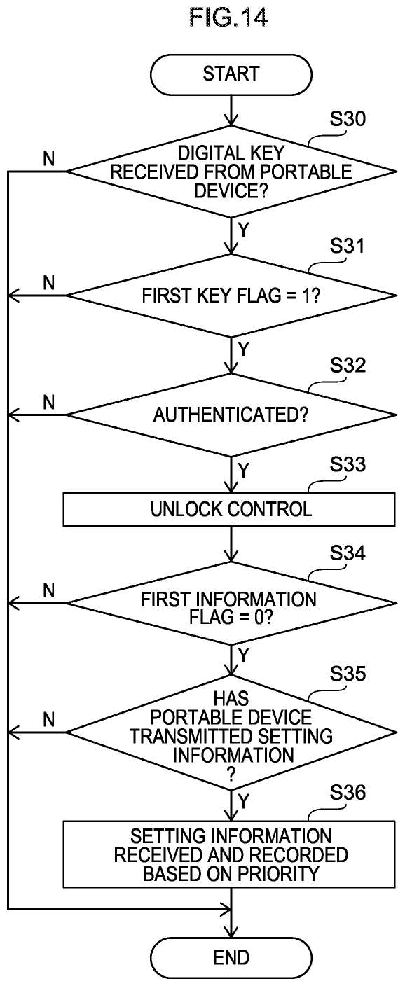

The CPU 71A repeatedly executes the processing of the flowchart of FIG. 14 every time a predetermined period of time elapses.

At step S30, the CPU 71A determines whether or not the digital key has been received from the portable device 80.

In a case in which the determination at step S30 is YES, the CPU 71A proceeds to step S31 to determine whether or not the value of the first key flag is “1”.

In a case in which the determination at step S31 is YES, the CPU 71A proceeds to step S32, and performs authentication of the digital key acquired from the portable device 80 using the digital key acquired from the management server 20.

In a case in which the digital key acquired from the portable device 80 is authenticated at step S32, the CPU 71A proceeds to step S33, and controls the actuator 54 to switch the door lock devices 53 that were in the locked state to the unlocked state.

Next, the CPU 71A proceeds to step S34 to determine whether or not the value of the first information flag is “0”.

In a case in which the determination at step S34 is YES, the CPU 71A proceeds to step S35 to determine whether or not the portable device 80 is transmitting the setting information to the second vehicle 70.

In a case in which the determination at step S35 is YES, the CPU 71A proceeds to step S36 to cause the wireless communication I/F 71E to receive the setting information. At this time, the portable device 80 sequentially transmits the respective setting information to the second vehicle 70 according to the priority specified in the setting information list 25 recorded in the portable device 80. Namely, the portable device 80 transmits the respective setting information to the second vehicle 70 in the order of the boarding setting information, the travel setting information, and the deboarding setting information. In this case, for example, when transmitting the boarding setting information, the wireless communication I/F 81E may transmit the door lock setting information after transmitting the seat position setting information. Further, the wireless communication I/F 81E may transmit the travel-related setting information prior to the entertainment related setting information. Moreover, the wireless communication I/F 81E may transmit the travel-related setting information in the order of the driving assistance setting information, the headlight setting information, the door lock setting information, and the navigation setting information. The wireless communication I/F 81E may transmit the deboarding setting information in the order of, for example, the interior light setting information and the door lock setting information.

The respective setting information received by the wireless communication I/F 71E is recorded in the storage 71D in the received order. This enables the seat control section 711, the driving assistance control section 712, the door lock control section 713, the lighting control section 714, the display control section 715, and the audio control section 716 to perform control based on the setting information recorded in the storage 71D. For example, in a case in which only the seat position setting information is recorded in the storage 71D, the seat control section 711 controls the actuator 42 and the actuator 48 based on the seat position setting information recorded in the storage 71D. On the other hand, at this time, the driving assistance control section 712, the door lock control section 713, the lighting control section 714, the display control section 715, and the audio control section 716 cannot execute control based on the setting information recorded in the storage 71D.

In a case in which the determination at step S30 to step S32, step S34 or step S35 is NO, or in a case in which the processing at step S36 has ended, the CPU 71A temporarily ends the processing of the flowchart of FIG. 14.

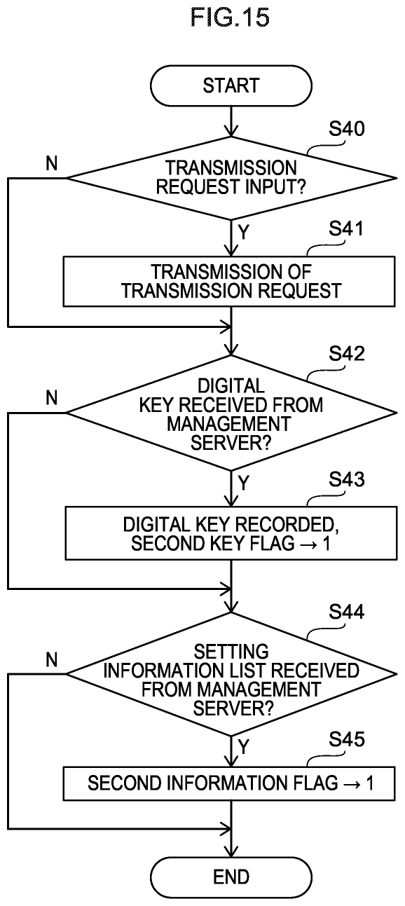

Next, explanation follows regarding processing performed by the CPU 81A of the portable device 80. The CPU 81A repeatedly executes the processing of the flowchart of FIG. 15 every time a predetermined period of time elapses.

At step S40, the CPU 81A determines whether or not the transmission request has been input via the display (touch panel) 82.

In a case in which the determination at step S40 is YES, the CPU 81A proceeds to step S41, and controls the wireless communication I/F 81E so as to transmit the transmission request to the management server 20.

In a case in which the determination at step S40 is NO, or in a case in which the processing at step S41 has ended, at step S42, the CPU 81A determines whether or not the digital key has been received from the management server 20.

In a case in which the determination at step S42 is YES, the CPU 81A proceeds to step S43, records the acquired digital key in the storage 81D, and sets the value of a second key flag to “1”. Note that the initial value of the second key flag is “0”.

In a case in which the determination at step S42 is NO, or in a case in which the processing of step S43 has ended, the CPU 81A proceeds to step S44 to determine whether or not the setting information list 25 has been received from the management server 20.

In a case in which the determination at step S44 is YES, the CPU 81A proceeds to step S45, and sets the value of a second information flag to “1”. Note that the initial value of the second information flag is “0”.

In a case in which the determination at step S44 is NO, or in a case in which the processing at step S45 has ended, the CPU 81A temporarily ends the processing of the flowchart of FIG. 15.

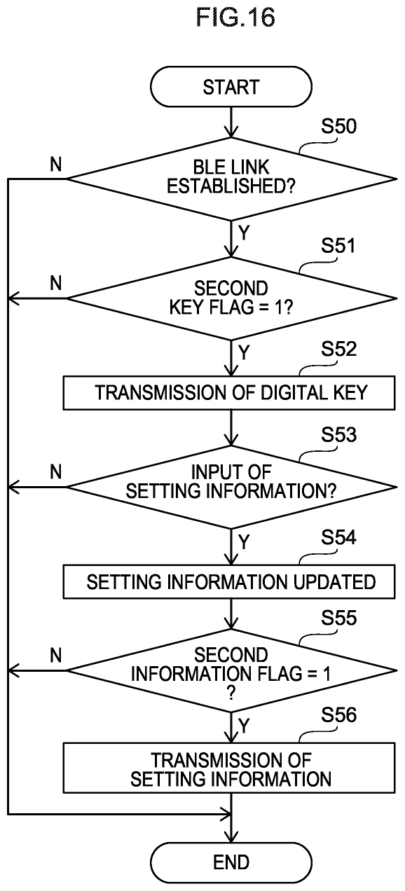

The CPU 81A repeatedly executes the processing of the flowchart of FIG. 16 every time a predetermined period of time elapses.

At step S50, the CPU 81A determines whether or not a BLE link has been established with the second vehicle 70 (the wireless communication I/F 71E). A BLE link is established when the distance between the portable device 80 and the second vehicle 70 is equal to or less than a predetermined distance.

In a case in which the determination at step S50 is YES, the CPU 81A proceeds to step S51 to determine whether or not the value of the second key flag is “1”.

In a case in which the determination at step S51 is YES, the CPU 81A proceeds to step S52, and controls the wireless communication I/F 81E so as to transmit the digital key to the second vehicle 70.

When the processing of step S52 has ended, the CPU 81A proceeds to step S53, and determines whether or not an instruction to change the content of the setting information recorded in the storage 81D has been input into the portable device 80 via the display 82.

In a case in which the determination at step S53 is YES, the CPU 81A proceeds to step S54 to update the content of the setting information recorded in the storage 81D. For example, in a case in which setting information relating to the sliding position of the driver's seat 36 is already recorded in the storage 81D, when new setting information relating to the sliding position is input via the display 82, the CPU 81A updates the setting information relating to the sliding position recorded in the storage 81D.

When the processing of step S54 has ended, the CPU 81A proceeds to step S55 to determine whether or not the value of the second information flag is “1”.

In a case in which the determination at step S55 is YES, the CPU 81A proceeds to step S56, and causes the wireless communication I/F 81E to transmit the setting information specified in the setting information list 25 to the second vehicle 70. At this time, the portable device 80 transmits the respective setting information to the second vehicle 70 in the manner described above based on the priority. Note that at this time, the wireless communication I/F 81E may simultaneously transmit data representing the boarding setting information and data representing the digital key to the second vehicle 70. For example, in a case in which the seat position setting information is transmitted prior to the door lock setting information, the wireless communication I/F 81E may use one packet to transmit data representing the seat position setting information and data representing the digital key to the second vehicle 70.

In a case in which the determination at step S50, step S51, step S53 or step S55 is NO, or in a case in which the processing of step S56 has ended, the CPU 81A temporarily ends the processing of the flowchart of FIG. 16.

As described above, in a case in which a failure has occurred in wireless communication between the management server 20 and the second vehicle 70, the portable device 80 of the present exemplary embodiment acquires setting information, which is information relating to user settings of the onboard devices of the first vehicle 30, from the management server 20, for example. Moreover, the portable device 80 transmits the setting information relating to the onboard devices of the first vehicle 30 to the second vehicle 70 by wireless communication with the second vehicle 70. Accordingly, even in a case in which a failure has occurred in wireless communication between the management server 20 holding the setting information and the second vehicle 70, the second vehicle 70 can receive the setting information.

Moreover, the second vehicle 70 receives the setting information from the portable device 80 only in a case in which the second vehicle 70 authenticates the digital key transmitted by the portable device 80. Accordingly, for example, the onboard devices of the second vehicle 70 are not controlled based on the setting information transmitted by a portable device owned by a person who is not a member of the system 10.

Furthermore, based on the priority specified in the setting information list 25, the portable device 80 sequentially transmits the respective setting information to the second vehicle 70. Namely, in the present exemplary embodiment, the setting information is transmitted to the second vehicle 70 in the order of the boarding setting information, the travel setting information, and the deboarding setting information. In this manner, the boarding setting information is first transmitted to the second vehicle 70. Accordingly, for example, before the second vehicle 70 completes receiving the travel setting information and the deboarding setting information, the sliding position and the reclining position of the driver's seat 36 of the second vehicle 70 can be changed based on the setting information relating to the sliding position and the reclining position of the driver's seat 36. Accordingly, regardless of whether or not the second vehicle 70 has completed receiving the travel setting information and the deboarding setting information, the sliding position and the reclining position of the driver's seat 36 can be set to a position that is preferable for the user UE when the user UE boards the second vehicle 70. Moreover, even in a case in which the second vehicle 70 is unable to receive the deboarding setting information due to a communication failure, for example, the display 33, the headlights 56, the audio device 60, the car navigation system, and the execution system of driving assistance control can be controlled based on the respective setting information during travel of the second vehicle 70.

Although the portable device, the setting information transmission method, and the non-transitory recording medium according to the exemplary embodiment have been explained above, appropriate design modifications to the portable device, the setting information transmission method, and the non-transitory recording medium can be made within a range that does not depart from the gist of the present disclosure.

For example, the setting information of the first vehicle 30 may be input into the above-described operation terminal, and the management server 20 may create (update) the setting information list 25 based on the setting information.

The portable device 80 may receive the setting information for the first vehicle 30 from the first vehicle 30 by wireless communication, and may wirelessly transmit the setting information acquired from the first vehicle 30 to the second vehicle 70. For example, when the setting information recorded in the storage 31D of the first vehicle 30 is updated, when the start button 64 of the first vehicle 30 is switched from an ON state to an OFF state, or when the door lock device 53 is switched from the unlocked state to the locked state, the first vehicle 30 may wirelessly transmit the setting information to the portable device 80. In this case, the portable device 80 may classify the setting information acquired from the first vehicle 30 based on the priority described above.

The first vehicle 30 and the second vehicle 70 may include a steering wheel 34 (a movable member), a position of which is adjustable in the front-rear direction (an axial direction of the steering wheel 34), and an actuator for adjusting a position of the steering wheel 34. In this case, the ECUs 31 and 71 may control the actuator based on setting information relating to the position of the steering wheel 34 in the front-rear direction. Note that the setting information relating to the position of the steering wheel 34 in the front-rear direction is boarding setting information.

The first vehicle 30 and the second vehicle 70 may include a rearview mirror (a movable member), a position of which adjustable, and an actuator for adjusting the position of the rearview mirror. In this case, the ECUs 31 and 71 may control the actuator based on setting information relating to the position of the rearview mirror. Note that the setting information relating to the position of the rearview mirror is boarding setting information.

The first vehicle 30 and the second vehicle 70 may include a side mirror (a movable member), an angle of which is adjustable with respect to a vehicle body, and an actuator for adjusting an angle of the side mirror. In this case, the ECUs 31 and 71 may control the actuator based on setting information relating to the angle of the side mirror. Note that the setting information relating to the angle of the side mirror is boarding setting information.

The second vehicle 70 and the portable device 80 may perform wireless communication using at least one of radio frequency (RF) band wireless communication, low frequency (LF) band wireless communication, near field communication (NFC) standard wireless communication or Wi-Fi.

The system 10 may be configured using a communication method conforming to a Car Connectivity Consortium (CCC) standard. Namely, the management server 20 may be an owner/friend device OEM server conforming to the CCC standard, and the portable device 80 may be an owner device or a friend device. In this case, the second vehicle 70 may authenticate the portable device 80 using BLE communication conforming to the CCC standard and a digital key. Moreover, the second vehicle 70 may execute the processing of step S33 when the second vehicle 70 has authenticated the portable device 80.

Alternatively, the portable device 80 may transmit the setting information to the second vehicle 70 when the second vehicle 70 authenticates the portable device 80 using wireless communication and the portable device 80 authenticates the second vehicle 70 using wireless communication.

In a case in which the second vehicle 70 authenticates the portable device 80, the portable device 80 may measure the distance to the second vehicle 70 using an ultra wideband (UWB) conforming to the CCC standard, and when the portable device 80 determines that the distance between the portable device 80 and the second vehicle 70 is equal to or less than a predetermined distance, the processing of step S33 and step S56 may be executed while using BLE communication. Alternatively, the processing of step S56 may be executed when the processing of step S33 is executed while using BLE communication.

The portable device 80 may be configured to switch between a state in which the setting information recorded in the storage 81D can be transmitted to the second vehicle 70 and a state in which the setting information cannot be transmitted. These two states are implemented when, for example, a predetermined instruction is input from the display 82 into the portable device 80.

In a case in which the vehicle type codes of the first vehicle 30 and the second vehicle 70 are different from each other, the portable device 80 may convert data representing the setting information for the first vehicle 30 into data usable by the vehicle group of the system 10, and then transmit this data to the vehicles of the system 10. In this case, the portable device 80 may acquire the vehicle codes of the first vehicle 30 and the vehicle group of the system 10 recorded in the storage 21D of the management server 20 by wireless communication. Moreover, the portable device 80 may acquire these vehicle codes by short-range wireless communication with the first vehicle 30 and the vehicle group of the system 10. Further, in a case in which the digital key for the first vehicle 30 recorded in the portable device 80 includes data representing the vehicle code of the first vehicle 30, and the digital key for the second vehicle 70 recorded in the portable device 80 includes data representing the vehicle code of the second vehicle 70, the portable device 80 may acquire the vehicle codes of the first vehicle 30 and the second vehicle 70 from these digital keys.

When the onboard devices of the second vehicle 70 become controllable based on the setting information due to the setting information being recorded in the storage 71D of the second vehicle 70, notification devices of the second vehicle 70 and the portable device 80 may inform the user UE thereof. The notification device of the second vehicle 70 is, for example, the display 33 and speakers of the audio device 60. The notification device of the portable device 80 is, for example, the display 82.

The first vehicle 30 need not be a vehicle owned by the user UE. For example, the first vehicle 30 may be a vehicle of a car sharing system. Similarly, the second vehicle 70 need not be a vehicle of the car sharing system. For example, the second vehicle 70 may be a vehicle owned by the user UE.

Note that the processing executed by each CPU reading and executing software (a program) in the above-described exemplary embodiment may be executed by various types of processor other than a CPU. Such processors include programmable logic devices (PLD) that allow circuit configuration to be modified post-manufacture, such as a field-programmable gate array (FPGA), and dedicated electric circuits, these being processors including a circuit configuration custom-designed to execute specific processing, such as an application specific integrated circuit (ASIC). Further, the respective processing may be executed by any one of these various types of processor, or by a combination of two or more of the same type or different types of processor. The hardware structure of these various types of processors is an electric circuit combining circuit elements such as semiconductor elements.

What is claimed is:

1. A portable device comprising:
a processor configured to:
acquire setting information relating to user settings of an onboard device of a first vehicle; and
in a case in which a distance between the portable device and a second vehicle, which is different from the first vehicle and includes another onboard device, is a predetermined distance or less, cause transmission of the setting information to the second vehicle.

2. The portable device according to claim 1, wherein the processor is configured to cause transmission of the setting information to the second vehicle by communication conforming to a Bluetooth standard.

3. The portable device according to claim 1, wherein the processor is configured to cause transmission, to the second vehicle, of authentication data for the portable device to be authenticated at the second vehicle.

4. The portable device according to claim 1, wherein:
the setting information includes:
boarding setting information relating to the onboard device which is controllable, based on the user settings, before the first vehicle and the second vehicle begin travel, and
travel setting information relating to the onboard device which is controllable, based on the user settings, during travel of the first vehicle and the second vehicle; and
the processor is configured to cause transmission of the travel setting information to the second vehicle after causing transmission of the boarding setting information to the second vehicle.

5. The portable device according to claim 4, wherein:
the second vehicle includes at least one movable member, a position of the at least one movable member being changeable; and
the boarding setting information includes setting information relating to the position of the at least one movable member.

6. The portable device according to claim 5, wherein the at least one movable member is a movable seat.

7. The portable device according to claim 4, wherein the travel setting information includes travel-related setting information relating to the onboard device which is controllable, based on the user settings, during travel of the first vehicle and the second vehicle, and relating to safe travel of the first vehicle and the second vehicle.

8. The portable device according to claim 7, wherein the travel-related setting information is related to the onboard device, which comprises at least one of a car navigation system, an execution system of driving assistance control, headlights or a door lock device.

9. The portable device according to claim 1, wherein the processor is configured to acquire the setting information, via wireless communication, from the first vehicle or an external device.

10. The portable device according to claim 1, wherein:
the portable device comprises an input section by which it can receive an instruction to change a content of the setting information acquired by the processor; and
the portable device is configured to change the content of the setting information acquired by the processor, based on the instruction received via the input section.

11. The portable device according to claim 1, which is an owner device conforming to a Car Connectivity Consortium (CCC) standard.

12. The portable device according to claim 1, wherein:
the portable device is capable of conducting wireless communication with the second vehicle, conforming to a Car Connectivity Consortium (CCC) standard; and
in a case in which a door lock device of the second vehicle is switched from a locked state to an unlocked state by wireless communication conforming to the CCC standard, the processor causes transmission, to the second vehicle, of the setting information relating to the other onboard device at the second vehicle.

13. A setting information transmission method of transmitting, from a portable device to a vehicle, setting information relating to user settings of an onboard device, the method comprising, by a processor:
acquiring the setting information of the onboard device, wherein the onboard device is in a first vehicle; and
in a case in which a distance between the portable device and a second vehicle, which is different from the first vehicle, is a predetermined distance or less, causing transmission of the setting information to the second vehicle which includes another onboard device.

14. A non-transitory recording medium storing a program executable by a computer to perform processing, the processing comprising:
acquiring setting information relating to user settings of an onboard device of a first vehicle; and
in a case in which a distance to a second vehicle, which is different from the first vehicle and includes another onboard device, is a predetermined distance or less, causing transmission of the setting information to the second vehicle.
